(19) United States
(12) Patent Application Publication
(10) Pub. No.: US 2023/0351562 A1
(43) Pub. Date: Nov. 2, 2023

(54) STANDARD DYNAMIC RANGE (SDR) TO HIGH DYNAMIC RANGE (HDR)INVERSE TONE MAPPING USING MACHINE LEARNING

(71) Applicant: SAMSUNG ELECTRONICS CO., LTD., Suwon-si (KR)

(72) Inventors: Bowen Zhao, Irvine, CA (US); Chenguang Liu, Tustin, CA (US); Dung Trung Vo, Costa Mesa, CA (US); McClain Craig Nelson, Anaheim, CA (US); Chang Su, Foothill Ranch, CA (US)

(21) Appl. No.: 18/304,651

(22) Filed: Apr. 21, 2023

Related U.S. Application Data
(60) Provisional application No. 63/336,120, filed on Apr. 28, 2022.

(51) Int. Cl. G06T 5/00; G06V 10/70; G06V 10/56; G06T 5/40

(52) U.S. Cl. CPC G06T 5/009; G06V 10/70; H04N 23/741; G06V 10/56; G06T 5/40; G06T 2207/20081; G06T 2207/10024; G06T 2207/20208

(57) ABSTRACT

One embodiment provides a method comprising receiving, as input, standard dynamic range (SDR) content, and obtaining statistics information corresponding to the SDR content. The method further comprises determining, based on the statistics information, one or more parameters for an inverse tone mapping (ITM) curve using a machine learning model. The method further comprises converting the SDR content to high dynamic range (HDR) content using the ITM curve. The resulting HDR content is provided to a display device for presentation.

### CROSS-REFERENCE TO RELATED APPLICATIONS

The present application claims priority to U.S. Provisional Patent Application No. 63/336,120, filed on Apr. 28, 2022, incorporated by reference in its entirety.

### TECHNICAL FIELD

One or more embodiments generally relate to consumer electronics, in particular, a method and system that provides standard dynamic range (SDR) to high dynamic range (HDR) inverse tone mapping using machine learning.

### BACKGROUND

Standard Dynamic Range (SDR) is a display signal technology primarily used to represent light in images and videos shown on cathode ray tube (CRT) displays. Some forms of cinematography and photography also use SDR.

Compared to SDR, High Dynamic Range (HDR) is a much more advanced display signal technology that renders screen light intensity with a wide or high dynamic range (i.e., creates a high degree of color clarity and contrast). HDR is used in computing, cinematography, photography and consumer electronic devices equipped with state-of-the-art display screens, such as televisions and smartphones.

### SUMMARY

One embodiment provides a method comprising receiving, as input, standard dynamic range (SDR) content, and obtaining statistics information corresponding to the SDR content. The method further comprises determining, based on the statistics information, one or more parameters for an inverse tone mapping (ITM) curve using a machine learning model. The method further comprises converting the SDR content to high dynamic range (HDR) content using the ITM curve. The resulting HDR content is provided to a display device for presentation.

Another embodiment provides a system comprising at least one processor and a non-transitory processor-readable memory device storing instructions that when executed by the at least one processor causes the at least one processor to perform operations. The operations include receiving, as input, SDR content, and obtaining statistics information corresponding to the SDR content. The operations further include determining, based on the statistics information, one or more parameters for an ITM curve using a machine learning model. The operations further include converting the SDR content to HDR content using the ITM curve. The resulting HDR content is provided to a display device for presentation.

One embodiment provides a non-transitory processor-readable medium that includes a program that when executed by a processor performs a method. The method comprises receiving, as input, SDR content, and obtaining statistics information corresponding to the SDR content. The method further comprises determining, based on the statistics information, one or more parameters for an ITM curve using a machine learning model. The method further comprises converting the SDR content to HDR content using the ITM curve. The resulting HDR content is provided to a display device for presentation.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a fuller understanding of the nature and advantages of the embodiments, as well as a preferred mode of use, reference should be made to the following detailed description read in conjunction with the accompanying drawings, in which:

FIG. 1 illustrates an example computing architecture for implementing fully automatic standard dynamic range (SDR) to high dynamic range (HDR) inverse tone mapping (ITM) using machine learning, in one or more embodiments;

FIG. 2 illustrates an example ground truth HDR mastering system for implementing generation of training data, in one or more embodiments;

FIG. 3 illustrates an example machine learning model training system for implementing training of a machine learning model for use in SDR to HDR ITM, in one or more embodiments;

FIG. 4 illustrates an example graph plot of an example ground truth ITM curve, in one or more embodiments;

FIG. 5 illustrates an example on-device SDR to HDR ITM system, in one or more embodiments;

FIG. 6 illustrates another example on-device SDR to HDR ITM system, in one or more embodiments;

FIG. 7 illustrates an example off-device SDR to HDR ITM system, in one or more embodiments;

FIG. 8 illustrates an example of visual differences between SDR content and converted HDR content, in one or more embodiments;

FIG. 9 illustrates an example of visual differences between SDR content, ground truth HDR content, and converted HDR content, in one or more embodiments;

FIG. 10 is a flowchart of an example process for fully automatic SDR to HDR ITM using machine learning, in one or more embodiments; and

FIG. 11 is a high-level block diagram showing an information processing system comprising a computer system useful for implementing the disclosed embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments generally relate to consumer electronics, in particular, a method and system that provides standard dynamic range (SDR) to high dynamic range (HDR) inverse tone mapping using machine learning. One embodiment provides a method comprising receiving, as input, SDR content, and obtaining statistics information corresponding to the SDR content. The method further comprises determining, based on the statistics information, one or more parameters for an inverse tone mapping (ITM) curve using a machine learning model. The method further comprises converting the SDR content to HDR content using the ITM curve. The resulting HDR content is provided to a display device for presentation.

Another embodiment provides a system comprising at least one processor and a non-transitory processor-readable memory device storing instructions that when executed by the at least one processor causes the at least one processor to perform operations. The operations include receiving, as input, SDR content, and obtaining statistics information corresponding to the SDR content. The operations further include determining, based on the statistics information, one or more parameters for an ITM curve using a machine learning model. The operations further include converting the SDR content to HDR content using the ITM curve. The resulting HDR content is provided to a display device for presentation.

One embodiment provides a non-transitory processor-readable medium that includes a program that when executed by a processor performs a method. The method comprises receiving, as input, SDR content, and obtaining statistics information corresponding to the SDR content. The method further comprises determining, based on the statistics information, one or more parameters for an ITM curve using a machine learning model. The method further comprises converting the SDR content to HDR content using the ITM curve. The resulting HDR content is provided to a display device for presentation.

For expository purposes, the term “creative intent” is indicative of how an image is intended to be viewed. For example, creative intent may indicate a particular visualization of an image that a content provider or content creator (e.g., a color grading expert or colorist at a studio) intends for an audience to see, such as a desired/intended color tone of the image.

Even though HDR displays are getting more and more popular in the market, creating content using HDR is still more complex and expensive than SDR. Due to the large amounts of legacy SDR content and low costs of creating SDR content, SDR content still dominates the market.

Displaying SDR content on a HDR display does not take advantage of the display's HDR rendering capabilities. Conventional technologies for converting SDR content to HDR content, however, are complicated. For example, color grading SDR content using color grading experts may be too expensive. As another example, converting SDR content utilizing conventional algorithms with engineer tuning may result in sub-optimal picture quality.

One or more embodiments provide fully automatic SDR to HDR ITM using machine learning. Specifically, in one embodiment, SDR content is received as input, an ITM curve for pixel wise ITM is generated using an artificial intelligence (AI) machine learning model, the SDR content is converted to HDR content using the ITM curve, and the HDR content is provided as output. In one embodiment, the machine learning model comprises one of a neural network, a support vector machine (SVM), or another architecture.

In one embodiment, an ITM curve is an n-th order polynomial curve. For example, in one embodiment, the n-th order polynomial ITM curve is one of a Bernstein polynomial curve or a Bézier curve. For example, in one embodiment, the machine learning model is trained to learn heuristic features which represent SDR tonality, and to generate n coefficients for a flexible n-th order Bernstein polynomial curve for use in converting SDR signals of SDR content (received as input) to HDR signals of HDR content (provided as output).

In one embodiment, an ITM curve is parameterized. Parameters of an ITM curve are based on statistics information (e.g., histogram, linear luminance percentiles, etc.) for SDR content. In one embodiment, SDR content and corresponding metadata including statistics information for the SDR content are both received as input, and parameters for an ITM curve are generated using the machine learning model. The machine learning model consumes little or no hardware resources. By comparison, conventional solutions utilize deep learning models for end-to-end SDR to HDR conversion that have millions of parameters and require a large amount of hardware resources (e.g., a large amount of system on chip (SoC) gate counts), making such solutions costly.

In one embodiment, a ground truth ITM curve is extracted from training data comprising paired SDR and HDR training samples (e.g., paired SDR and HDR images). The training data provides one-to-many mapping of pixel coordinates in SDR to HDR, whereas the ground truth ITM curve provides one-to-one mapping of pixel coordinates in SDR to HDR.

In one embodiment, the machine learning model is deployed in software, such as a Digital Signal Processor (DSP) or a central processing unit (CPU), thereby removing the need for extra hardware resources (e.g., a TV requires no extra hardware resources). As such, no extra costs relating to hardware are incurred. Additionally, creators and distributors of SDR content need not incur additional costs as SDR content is received as-is.

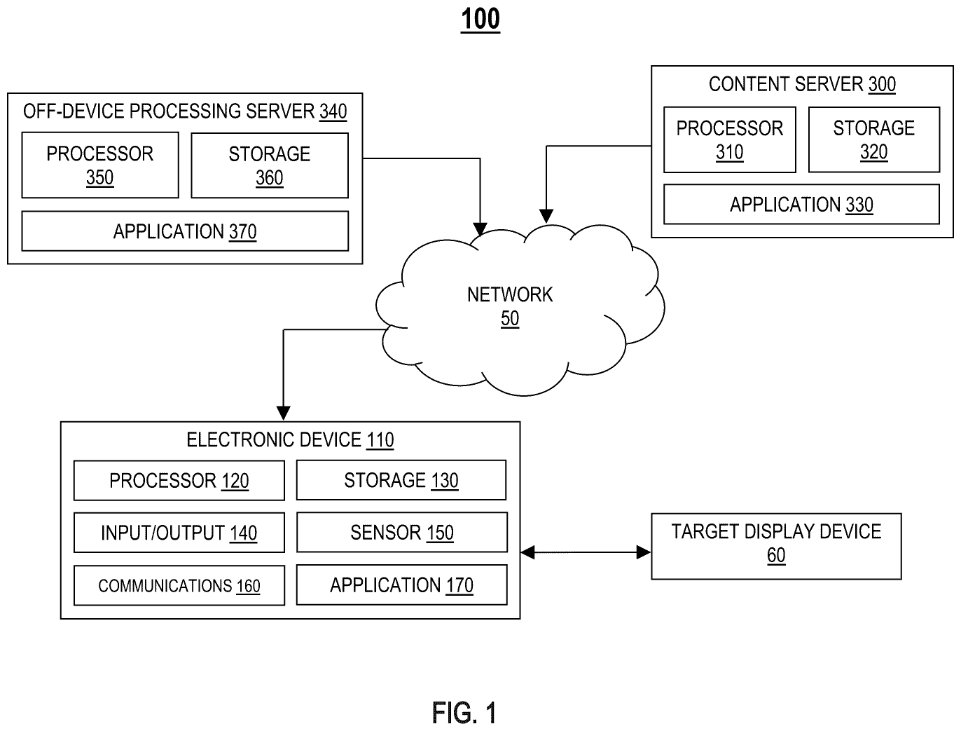

FIG. 1 illustrates an example computing architecture 100 for implementing fully automatic SDR to HDR ITM using machine learning, in one or more embodiments. The computing architecture 100 comprises an electronic device 110 including resources, such as one or more processor units 120 and one or more storage units 130. One or more applications 170 may execute/operate on the electronic device 110 utilizing the resources of the electronic device 110.

The computing architecture 100 comprises a target display device 60 integrated in or coupled to the electronic device 110. The display device 60 is a consumer display with HDR rendering capability (e.g., a HDR display).

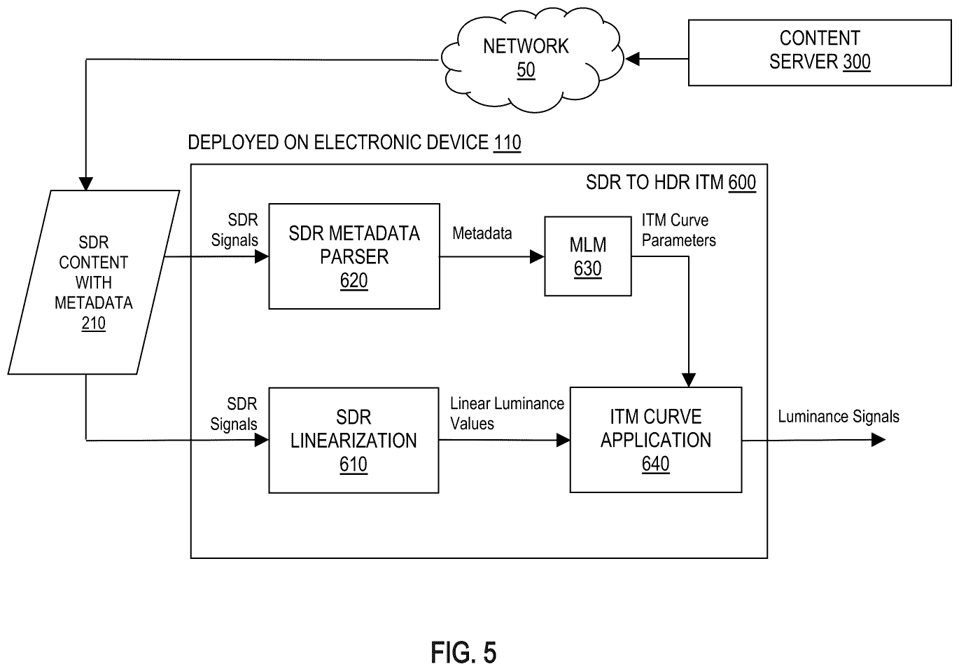

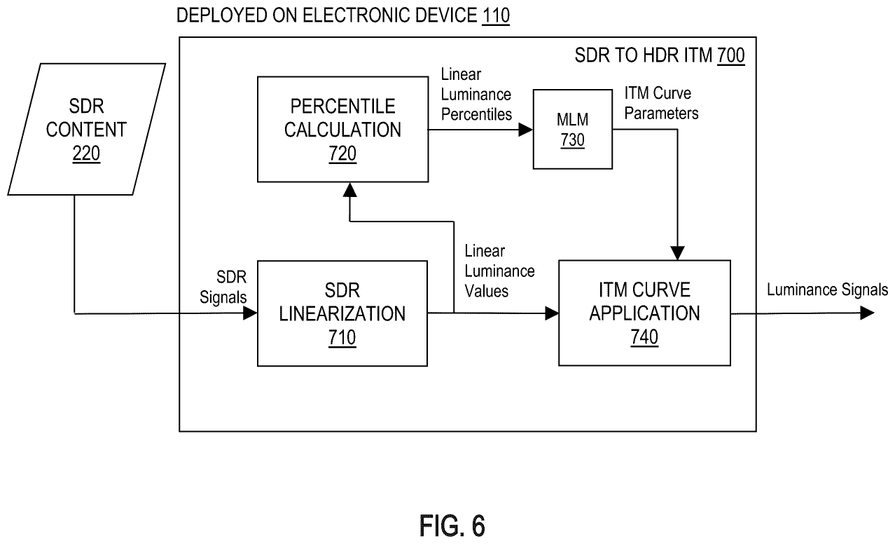

In one embodiment, fully automatic SDR to HDR ITM using machine learning is performed on-device (i.e., on the electronic device 110). Specifically, the one or more applications 170 executing/operating on the electronic device 110 include a SDR to HDR ITM system (e.g., SDR to HDR ITM system 600 in FIG. 5 or SDR to HDR ITM system 700 in FIG. 6) configured to perform on-device SDR to HDR conversion using a single ITM curve generated using machine learning. As described in detail later herein, the SDR to HDR ITM system on the electronic device 110 is configured to: (1) receive, as input, SDR content (e.g., a SDR video), (2) generate, using an AI machine learning model, a flexible ITM curve based on the SDR content, (3) convert the SDR content to HDR content using the ITM curve, and (4) provide the resulting converted HDR content as output for presentation on the display device 60.

In one embodiment, SDR content has corresponding metadata which comprises per frame or scene statistics information for the entire SDR content (e.g., the entire SDR video). For example, in one embodiment, the corresponding metadata comprises, for each SDR image of the SDR content, a corresponding histogram or corresponding linear luminance percentiles. Linear luminance percentiles corresponding to a SDR image are linear luminance values sampled from a cumulated distribution function (CDF) of the SDR image based on pre-defined sampling percentage values (i.e., pre-defined percentages for sampling purposes). Linear luminance percentiles corresponding to a SDR image represent a distribution (i.e., number) of pixels in the SDR image.

Examples of the electronic device 110 that the display device 60 is integrated into or coupled to include, but are not limited to, a television (TV) (e.g., a smart TV), a mobile electronic device (e.g., an optimal frame rate tablet, a smart phone, a laptop, etc.), a wearable device (e.g., a smart watch, a smart band, a head-mounted display, smart glasses, etc.), a desktop computer, a gaming console, a video camera, a media playback device (e.g., a DVD player), a set-top box, an Internet of things (IoT) device, a cable box, a satellite receiver, etc.

In one embodiment, the electronic device 110 comprises one or more sensor units 150 including, but not limited to, a RGB color sensor, an IR sensor, an illuminance sensor, a color temperature sensor, a camera, a microphone, a GPS, a motion sensor, etc. In one embodiment, the one or more applications 170 on the electronic device 110 collects, via at least one sensor unit 150 of the electronic device 110, sensor data comprising one or more readings/measurements relating to one or more display characteristics of the display device 60 (e.g., a black level of the display device 60, and a peak luminance value of the display device 60) and/or one or more ambient lighting conditions (e.g., ambient illuminance, ambient CCT).

In one embodiment, at least one of the sensor units 150 is integrated in (i.e., pre-installed) or coupled (attached) to the display device 60.

In one embodiment, the electronic device 110 comprises one or more input/output (I/O) units 140 integrated in or coupled to the electronic device 110. In one embodiment, the one or more I/O units 140 include, but are not limited to, a physical user interface (PUI) and/or a graphical user interface (GUI), such as a remote control, a keyboard, a keypad, a touch interface, a touch screen, a knob, a button, a display screen, etc. In one embodiment, a user can utilize at least one I/O unit 140 to configure one or more parameters (e.g., pre-defined thresholds), provide user input, etc.

In one embodiment, the one or more applications 170 on the electronic device 110 may further include one or more software mobile applications loaded onto or downloaded to the electronic device 110, such as a camera application, a social media application, a video streaming application, etc. A software mobile application on the electronic device 110 may exchange data with the SDR to HDR ITM system on the electronic device 110 (or, alternatively, a SDR to HDR ITM system on a content server 300).

In one embodiment, the electronic device 110 comprises a communications unit 160 configured to exchange data with the display device 60. The communications unit 160 is further configured to exchange data with at least one content server 300 (e.g., receiving SDR content or converted HDR content from the content server 300) and/or at least one off-device processing server 340 (e.g., receiving a machine learning model from the off-device processing server 340), over a communications network/connection 50 (e.g., a wireless connection such as a Wi-Fi connection or a cellular data connection, a wired connection, or a combination of the two). The communications unit 160 may comprise any suitable communications circuitry operative to connect to a communications network and to exchange communications operations and media between the electronic device 110 and other devices connected to the same communications network 50. The communications unit 160 may be operative to interface with a communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In one embodiment, the content server 300 includes resources, such as one or more processing units 310 and one or more storage units 320. One or more applications 330 that provide higher-level services may execute/operate on the content server 300 utilizing the resources of the content server 300. For example, in one embodiment, the content server 300 provides an online platform for hosting one or more online services (e.g., a video streaming service, etc.) and/or distributing one or more software mobile applications. As another example, SDR content may be created on the content server 300. As yet another example, the content server 300 may comprise a cloud computing environment providing shared pools of configurable computing system resources and higher-level services. In one embodiment, the content server 300 is maintained by a cloud gaming service provider or an over-the-top (OTT) media service provider.

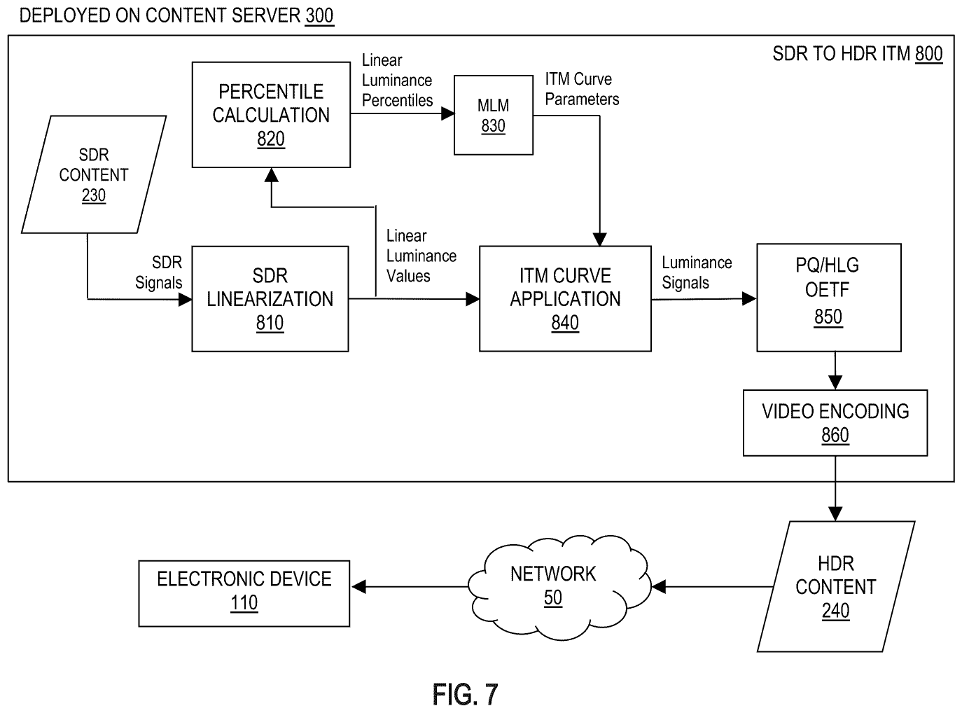

Alternatively, in another embodiment, fully automatic SDR to HDR ITM using machine learning is performed off-device instead (i.e., not on the electronic device 110). Specifically, the one or more applications 330 executing/operating on the content server 300 include a SDR to HDR ITM system (e.g., SDR to HDR ITM system 800 in FIG. 7) configured to perform off-device SDR to HDR conversion using a single ITM curve generated using machine learning. As described in detail later herein, the SDR to HDR ITM system on the content server 300 is configured to: (1) obtain, as input, SDR content (e.g., a SDR video), (2) generate, using an AI machine learning model, a flexible ITM curve based on the SDR content, (3) convert the SDR content to HDR content using the ITM curve, (4) encode the converted HDR content, and (5) provide, over the communications network 50, the resulting encoded HDR content as output to the electronic device 110 for presentation on the display device 60.

In one embodiment, the content server 300 is configured to exchange data with the off-device processing server 340 (e.g., receiving a machine learning model from the off-device processing server 340) over the communications network 50.

In one embodiment, an off-device processing server 340 includes resources, such as one or more processor units 350 and one or more storage units 360. One or more applications 370 that provide higher-level services may execute/operate on the off-device processing server 340 utilizing the resources of the off-device processing server 340. In one embodiment, the one or more applications 370 deployed on the off-device processing server 340 are configured to perform off-device (i.e., offline) processing. In one embodiment, the off-device processing comprises: (1) generating training data comprising paired SDR and HDR training samples, and (2) training a machine learning model based on the training data, wherein the resulting trained machine learning model may be deployed for use in SDR to HDR ITM. In one embodiment, a SDR to HDR ITM system and/or a machine learning model utilized by the system may be loaded onto or downloaded to the electronic device 110 (or, alternatively, the content server 300) from the off-device processing server 340 that maintains and distributes updates for the system and/or the machine learning model. In one embodiment, the off-device processing server 340 is maintained by a manufacturer (e.g., original equipment manufacturer (OEM)) of the electronic device 110.

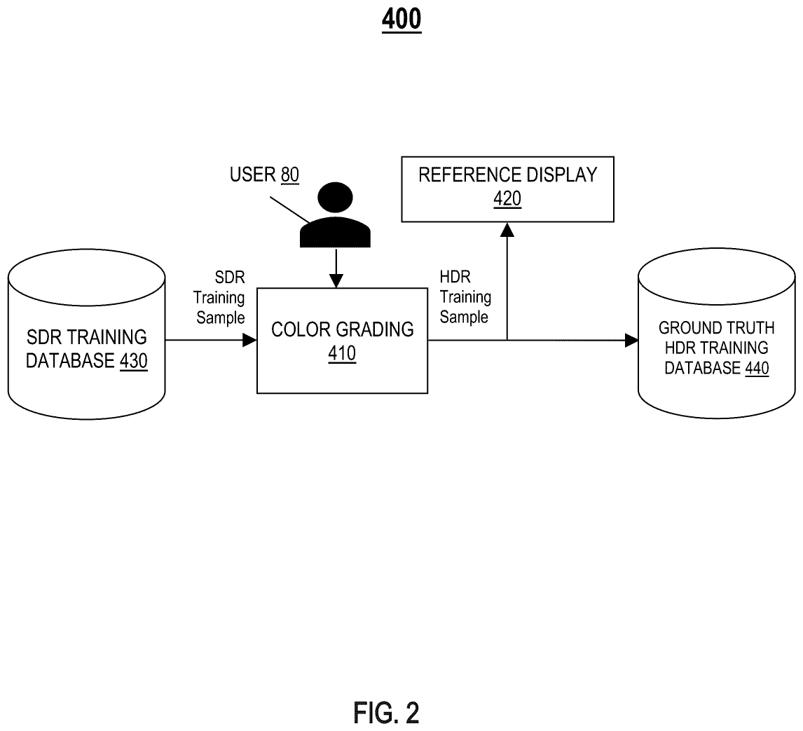

FIG. 2 illustrates an example ground truth HDR mastering system 400 for implementing generation of training data, in one or more embodiments. In one embodiment, the one or more applications 370 executing/operating on the off-device processing server 340 include a ground truth HDR mastering system 400 for generating training data comprising paired SDR and HDR training samples. In one embodiment, HDR training samples are generated by one or more color grading experts (i.e., colorists) at a studio with color grading tools.

In one embodiment, the ground truth HDR mastering system 400 comprises a color grading unit 410 configured to: (1) obtain, as input, one or more SDR training samples (e.g., SDR images), (2) provide color grading tools for color grading, based on input from a user 80 (e.g., a color grading expert at the studio), the one or more SDR training samples, and (3) provide, as output, one or more corresponding HDR training samples (e.g., HDR images) resulting from the color grading. The one or more corresponding HDR training samples represent ground truth HDR. The one or more SDR training samples and the one or more corresponding HDR training samples together form one or more paired SDR and HDR training samples for use as training data.

In one embodiment, the studio comprises a reference display 420 configured to: (1) receive a HDR training sample corresponding to a SDR training sample (e.g., from the color grading unit 410), and (2) provide the user 80 (e.g., the color grading expert at the studio) with visual feedback of one or more color graded adjustments (i.e., adjustments to the corresponding SDR training sample resulting from color grading) by displaying the HDR training sample.

The reference display 420 is an example reference monitor. In one embodiment, the reference display 420 is a high contrast HDR display, such as a HDR display with a peak luminance value of 4,000 nits and with a black level of zero nits.

In one embodiment, the off-device processing server 340 comprises a first database 430 maintaining a plurality of SDR training samples, and a second database 440 maintaining a plurality of HDR training samples. In one embodiment, the color grading unit 410 obtains one or more SDR training samples from the first database 430. In one embodiment, the color grading unit 410 provides one or more HDR training samples resulting from color grading to the second database 440 for storage.

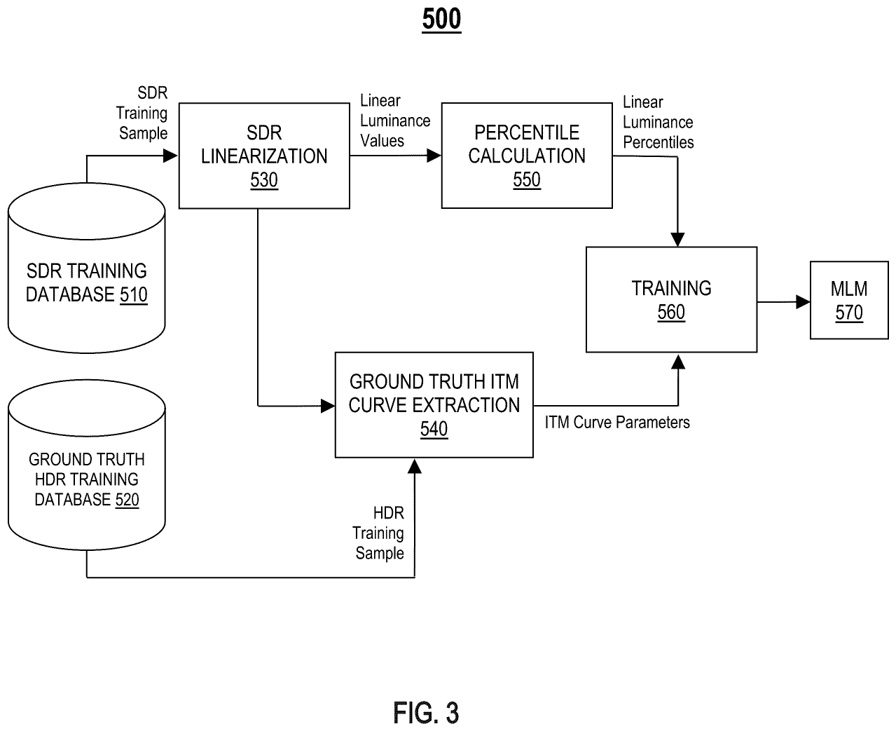

FIG. 3 illustrates an example machine learning model training system 500 for implementing training of a machine learning model for use in SDR to HDR ITM, in one or more embodiments. In one embodiment, the one or more applications 370 executing/operating on the off-device processing server 340 include a machine learning model training system 500 for training a machine learning model based on training data comprising paired SDR and HDR training samples, wherein the resulting trained machine learning model is configured to generate a single flexible ITM curve for converting SDR content to HDR content.

In one embodiment, the off-device processing server 340 comprises a first database 510 maintaining a plurality of SDR training samples, and a second database 520 maintaining a plurality of corresponding HDR training samples. In one embodiment, the SDR training samples and the corresponding HDR training samples together form paired SDR and HDR training samples for use as training data. In one embodiment, the HDR training samples represent ground truth HDR generated by a color grading expert at a studio with color grading tools (e.g., via the ground truth HDR mastering system 400).

In one embodiment, the training system 500 comprises a SDR linearization unit 530 configured to: (1) obtain, as input, one or more SDR training samples (e.g., from the first database 510), and (2) convert the one or more SDR training samples to linear luminance values with reference white (e.g., 100 nits or 203 nits).

In one embodiment, the training system 500 comprises a ground truth ITM curve extraction unit 540 configured to: (1) obtain, as input, a ground truth HDR dataset comprising one or more HDR training samples resulting from color grading of one or more SDR training samples (e.g., from the second database 520), (2) receive, as input, linear luminance values the one or more SDR training samples are converted to (e.g., from the SDR linearization unit 530), and (3) determine, based on the ground truth HDR dataset and the linear luminance values, a set of parameters for a single ground truth ITM curve. The ground truth ITM curve extraction unit 540 extracts the ground truth ITM curve with the set of parameters. In one embodiment, the ground truth ITM curve is an n-th order polynomial curve, and the n-th order polynomial curve is one of a Bernstein polynomial curve or a Bézier curve.

Mapping a SDR dataset (including SDR training samples) to a ground truth HDR dataset (including HDR training samples) results in one-to-many mapping of pixel coordinates in the SDR dataset to the ground truth HDR dataset. To ensure monotonicity of a ground truth ITM curve, the ground truth ITM curve extraction unit 540 extracts the ground truth ITM curve from a band of two-dimensional (2D) SDR-HDR pixel pairs with multiple potential outputs, wherein each SDR-HDR pixel pair comprises a linear luminance value of a pixel coordinate in the SDR dataset and a linear luminance value of a corresponding color graded pixel coordinate in the ground truth HDR dataset.

Let xᵢ generally denote a normalized linear luminance value of a SDR pixel (i.e., a pixel coordinate in a SDR training sample or SDR content). Let yᵢ generally denote a normalized linear luminance value of a color graded HDR pixel (i.e., a pixel coordinate in a HDR training sample resulting from color grading). Let \tilde{y}ᵢ generally denote a normalized linear luminance value of a predicted HDR pixel (i.e., a pixel coordinate in converted HDR content). Let p* generally denote an optimal parameter for a ground truth ITM curve.

If a ground truth HDR dataset comprises 4K content, the ground truth ITM curve extraction unit 540 determines optimal parameters p₁, . . . , p₁₀ for a ground truth ITM curve based on all 4K SDR-HDR pixel pairs (e.g., 3840×2160 pairs). Normalized linear luminance values \tilde{y}₁, . . . , \tilde{y}_{4K} of predicted HDR pixels of 4K content for presentation on a 4K display are represented in accordance with equation (1) provided below:

$$[ \begin{matrix}\begin{matrix}\begin{matrix}{\tilde{y}}_{1} \\ {\tilde{y}}_{2}\end{matrix} \\ ⋮\end{matrix} \\ {\tilde{y}}_{4 k}\end{matrix} ] = [ \begin{matrix}{p}_{1} ( \begin{matrix}10 \\ 1\end{matrix} ) {{x}_{1} ( 1 - {x}_{1} )}^{9} & + {p}_{2} ( \begin{matrix}10 \\ 2\end{matrix} ) {{x}_{1}^{2} ( 1 - {x}_{1} )}^{8} & … & + {p}_{10} ( \begin{matrix}10 \\ 10\end{matrix} ) {x}_{1}^{10} \\ {p}_{1} ( \begin{matrix}10 \\ 1\end{matrix} ) {{x}_{2} ( 1 - {x}_{2} )}^{9} & + {p}_{2} ( \begin{matrix}10 \\ 2\end{matrix} ) {{x}_{2}^{2} ( 1 - {x}_{2} )}^{8} & … & + {p}_{10} ( \begin{matrix}10 \\ 10\end{matrix} ) {x}_{2}^{10} \\ ⋮ & ⋮ & ⋱ & ⋮ \\ {p}_{1} ( \begin{matrix}10 \\ 1\end{matrix} ) {{x}_{4 K} ( 1 - {x}_{4 K} )}^{9} & + {p}_{2} ( \begin{matrix}10 \\ 2\end{matrix} ) {{x}_{4 K}^{2} ( 1 - {x}_{4 K} )}^{8} & … & + {p}_{10} ( \begin{matrix}10 \\ 10\end{matrix} ) {x}_{4 K}^{10}\end{matrix} ] = [ \begin{matrix}( \begin{matrix}10 \\ 1\end{matrix} ) {{x}_{1} ( 1 - {x}_{1} )}^{9} & ( \begin{matrix}10 \\ 2\end{matrix} ) {{x}_{1}^{2} ( 1 - {x}_{1} )}^{8} & … & ( \begin{matrix}10 \\ 10\end{matrix} ) {x}_{1}^{10} \\ ( \begin{matrix}10 \\ 1\end{matrix} ) {{x}_{2} ( 1 - {x}_{2} )}^{9} & ( \begin{matrix}10 \\ 2\end{matrix} ) {{x}_{2}^{2} ( 1 - {x}_{2} )}^{8} & … & ( \begin{matrix}10 \\ 10\end{matrix} ) {x}_{2}^{10} \\ ⋮ & ⋮ & ⋱ & ⋮ \\ ( \begin{matrix}10 \\ 1\end{matrix} ) {{x}_{4 K} ( 1 - {x}_{4 K} )}^{9} & ( \begin{matrix}10 \\ 2\end{matrix} ) {{x}_{4 K}^{2} ( 1 - {x}_{4 K} )}^{8} & … & ( \begin{matrix}10 \\ 10\end{matrix} ) {x}_{4 K}^{10}\end{matrix} ] * [ \begin{matrix}\begin{matrix}\begin{matrix}{p}_{1} \\ {p}_{2}\end{matrix} \\ ⋮\end{matrix} \\ {p}_{10}\end{matrix} ] = [ \begin{matrix}{{x}_{1} ( 1 - {x}_{1} )}^{9} & {{x}_{1}^{2} ( 1 - {x}_{1} )}^{8} & … & {x}_{1}^{10} \\ {{x}_{2} ( 1 - {x}_{2} )}^{9} & {{x}_{2}^{2} ( 1 - {x}_{2} )}^{8} & … & {x}_{2}^{10} \\ ⋮ & ⋮ & ⋱ & ⋮ \\ {{x}_{4 K} ( 1 - {x}_{4 K} )}^{9} & {{x}_{4 K}^{2} ( 1 - {x}_{4 K} )}^{8} & … & {x}_{4 K}^{10}\end{matrix} ] [ \begin{matrix}( \begin{matrix}10 \\ 1\end{matrix} ) & 0 & … & 0 \\ 0 & ( \begin{matrix}10 \\ 2\end{matrix} ) & … & 0 \\ ⋮ & ⋮ & ⋱ & ⋮ \\ 0 & 0 & … & ( \begin{matrix}10 \\ 10\end{matrix} )\end{matrix} ] * [ \begin{matrix}\begin{matrix}\begin{matrix}{p}_{1} \\ {p}_{2}\end{matrix} \\ ⋮\end{matrix} \\ {p}_{10}\end{matrix} ] . \qquad ( 1 )$$

Equation (1) can be summarized in accordance with equations (2)-(4) provided below:

\tilde{y}=A(x)*p (2),

wherein \tilde{y}∈R^{4K×1}, x∈R^{4K×1}, p∈R^{10×1}, and

$$A ( x ) = [ \begin{matrix}\begin{matrix}\begin{matrix}a ( {x}_{1} ) \\ a ( {x}_{2} )\end{matrix} \\ ⋮\end{matrix} \\ a ( 4 K )\end{matrix} ] ∈ {R}^{4 K \times 10} , \qquad ( 3 )$$

wherein A: x→A(x), R^{4K×1}→R^{4K×10}, and

$$a ( {x}_{i} ) = [ \begin{matrix}\begin{matrix}\begin{matrix}( \begin{matrix}10 \\ 1\end{matrix} ) {{x}_{i} ( 1 - {x}_{i} )}^{9} \\ ( \begin{matrix}10 \\ 2\end{matrix} ) {{x}_{i}^{2} ( 1 - {x}_{i} )}^{8}\end{matrix} \\ ⋮\end{matrix} \\ ( \begin{matrix}10 \\ 10\end{matrix} ) {x}_{i}^{10}\end{matrix} ] ∈ {R}^{1 \times 10} , \qquad ( 4 )$$

wherein a: xᵢ→a(xᵢ), R^{1×1}→R^{1×10}.

In one embodiment, if a ground truth HDR dataset comprises 4K content, the ground truth ITM curve extraction unit 540 is configured to determine an optimal parameter p* for a ground truth ITM curve in accordance with equation (5) provided below:

$${p}^{*} = arg {min}_{p} ( \frac{1}{4 K} ) {\sum }_{i = 1}^{4 K} {( {y}_{i} - {\tilde{y}}_{i} )}^{2} = arg {min}_{p} ( \frac{1}{4 K} ) {‖ y - A ( x ) * p ‖}^{2} . \qquad ( 5 )$$

Let p*_{unconstrained} generally denote an unconstrained least square optimal parameter. An unconstrained least square optimal parameter p*_{unconstrained} is determined in accordance with equation (6) provided below:

p*_{unconstrained}=(A^{T}A)⁻¹A^{T}y (6).

Monotonicity of a ground truth ITM curve is not ensured if the ground truth ITM curve is extracted with one or more unconstrained least square optimal parameters. To enforce monotonicity of an output ŷ given a hypothetical, monotonic, non-uniformly distributed input \hat{x}, the ground truth ITM curve extraction unit 540 generates sample points utilizing a sampling function represented by equation (7) provided below:

ŷ=A(\hat{x})*p

$$[ \begin{matrix}\begin{matrix}\begin{matrix}{\hat{y}}_{1} \\ {\hat{y}}_{2}\end{matrix} \\ ⋮\end{matrix} \\ {\hat{y}}_{N}\end{matrix} ] = [ \begin{matrix}\begin{matrix}\begin{matrix}a ( {\hat{x}}_{1} ) \\ a ( {\hat{x}}_{2} )\end{matrix} \\ ⋮\end{matrix} \\ a ( {\hat{x}}_{N} )\end{matrix} ] * p , \qquad ( 7 )$$

wherein 0≤p≤1 (i.e., upper and lower bounds of p are constrained).

In one embodiment, the ground truth ITM curve extraction unit 540 ensures strict monotonicity of a ground truth ITM curve by extracting the ITM curve with one or more constrained least square optimal parameters that are constrained in accordance with equation (8) provided below:

$$[ \begin{matrix}\begin{matrix}\begin{matrix}{\hat{y}}_{1} - {\hat{y}}_{2} \\ {\hat{y}}_{2} - {\hat{y}}_{3}\end{matrix} \\ ⋮\end{matrix} \\ {\hat{y}}_{N - 1} - {y}_{\hat{N}}\end{matrix} ] = [ \begin{matrix}\begin{matrix}\begin{matrix}a ( {\hat{x}}_{1} ) - a ( {\hat{x}}_{2} ) \\ a ( {\hat{x}}_{2} ) - a ( {\hat{x}}_{3} )\end{matrix} \\ ⋮\end{matrix} \\ a ( {\hat{x}}_{N - 1} ) - a ( {\hat{x}}_{N} )\end{matrix} ] * p \leq [ \begin{matrix}\begin{matrix}\begin{matrix}ε \\ ε\end{matrix} \\ ⋮\end{matrix} \\ ε\end{matrix} ] , \qquad ( 8 )$$

wherein ε is a small number that ensures strict monotonicity of the ITM curve, and ŷ₁+ε≤ŷ₂, ŷ₂+ε≤ŷ₃, . . . , ŷ_{N-1}+ε≤ŷ_{N}.

Let Lᵢ generally denote linear luminance percentiles of SDR input (e.g., a SDR training sample, a SDR image), wherein i=1, . . . , m. Let D(k) generally denote a CDF of a SDR input, wherein the CDF D(k) is calculated from a histogram of the SDR input, k=1, . . . , K, and K denotes a total number of bins of the histogram. Linear luminance percentiles Lᵢ of a SDR input are linear luminance values sampled from a CDF D(k) of the SDR input based on pre-defined sampling percentage values (i.e., pre-defined percentages for sampling purposes). Let Gᵢ generally denote pre-defined sampling percentage values. In one embodiment, an SDR input represents a particular SDR image of SDR content, and m linear luminance percentiles Lᵢ of the SDR image represents statistics information for a frame or scene captured in the SDR image. For example, m linear luminance percentiles Lᵢ of a SDR image represents tonality of the SDR image.

In one embodiment, the training system 500 comprises a percentile calculation unit 550 configured to: (1) receive, as input, linear luminance values that one or more SDR training samples are converted to (e.g., from the SDR linearization unit 530), and (2) calculate, based on the linear luminance values, m linear luminance percentiles Lᵢ of each SDR training sample. Specifically, for each SDR training sample, the percentile calculation unit 550 is configured to calculate a CDF D(k) of the SDR training sample, and sample m linear luminance percentiles Lᵢ from the CDF D(k) based on pre-defined sampling percentage values. In one embodiment, each linear luminance percentile Lᵢ sampled (via the percentile calculation unit 550) is normalized.

In one embodiment, for each SDR training sample, the percentile calculation unit 550 performs the following steps: First, the percentile calculation unit 550 calculates a corresponding maxRGB image by applying a max(R,G,B) function to a RGB (red, green, blue) image of the SDR training sample. Second, the percentile calculation unit 550 calculates a corresponding histogram h(k) with K bins. Third, the percentile calculation unit 550 calculates a corresponding CDF D(k) in accordance with equation (9) provided below:

D(k)=εⱼ₌₀^{k}h(k) (9).

Fourth, the percentile calculation unit 550 samples m linear luminance percentiles Lᵢ from the corresponding CDF D(k) based on pre-defined sampling percentage values Gᵢ. For example, in one embodiment, if m=9, the pre-defined sampling percentage values Gᵢ may include, but are not limited to, the following percentages: 1%, 5%, 10%, 25%, 50%, 75%, 90%, 95%, 100%.

In one embodiment, the training system 500 comprises a training unit 560 configured to: (1) receive, as input, for each of one or more SDR training samples, m linear luminance percentiles Lᵢ of the SDR training sample (e.g., from the percentile calculation unit 550), (2) receive, as input, a set of optimal parameters for a single ground truth ITM curve (e.g., from the ground truth ITM curve extraction unit 540), and (3) train a machine learning model 570 based on each input received. The resulting trained machine learning model 570 may be deployed for use in SDR to HDR ITM. In one embodiment, the set of optimal parameters comprises n pᵢ coefficients for an n-th order Bernstein polynomial curve, wherein i=1, . . . , n.

In one embodiment, the machine learning model 570 comprises a neural network configured to input m linear luminance percentiles Lᵢ and output n pᵢ coefficients for an n-th order Bernstein polynomial curve. For example, in one embodiment, the neural network comprises the following layers: (1) an input layer with m input neurons for receiving m linear luminance percentiles Lᵢ, (2) one or more hidden layers, and (3) an output layer with n output neurons for outputting n pᵢ coefficients. The machine learning model 570 learns heuristic features which represent tonality of SDR input (i.e., linear luminance percentiles Lᵢ of the SDR input), and generates n coefficients for a flexible n-th order Bernstein polynomial curve which is used to convert the SDR input to HDR output. In another embodiment, the machine learning model 570 comprises a SVM or another architecture.

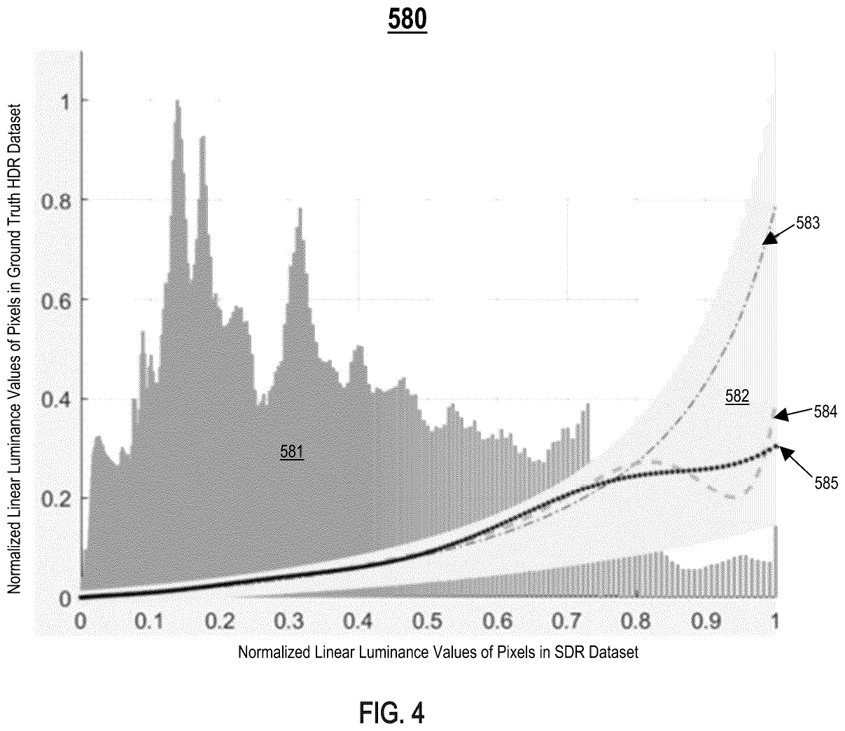

FIG. 4 illustrates an example graph plot 580 of an example ground truth ITM curve 585, in one or more embodiments. A horizontal axis of the graph plot 580 represents normalized linear luminance values of pixels in a SDR dataset comprising SDR training samples. A vertical axis of the graph plot 580 represents normalized linear luminance values of pixels in a ground truth HDR dataset comprising HDR training samples (resulting from color grading of the SDR training samples). As shown in FIG. 4, the graph plot 580 comprises a first area 581 representing histograms of the SDR dataset, and a second area 582 representing a band of 2D SDR-HDR pixel pairs with multiple potential outputs (i.e., one-to-many mappings of pixel coordinates in the SDR dataset to the ground truth HDR dataset).

As shown in FIG. 4, the graph plot 580 comprises the following curves: (1) a first ITM curve 583 extracted with one or more contrived rules based on all possible unique input values (i.e., all possible unique normalized linear luminance values of pixels in the SDR dataset), (2) a second ITM curve 584 extracted with one or more unconstrained least square optimal parameters based on all SDR-HDR pixel pairs, and (3) a third ITM curve 585 extracted with one or more constrained least square optimal parameters based on all SDR-HDR pixel pairs.

As shown by the second ITM curve 584 in FIG. 4, monotonicity of a ground truth ITM curve is not ensured if the ground truth ITM curve is extracted with one or more unconstrained least square optimal parameters. Therefore, as shown by the third ITM curve 585 in FIG. 4, the training system 500 instead extracts (e.g., via the ground truth ITM curve extraction unit 540), from the band of 2D SDR-HDR pixel pairs represented by the second area 582, a ground truth ITM curve with one or more constrained least square optimal parameters to ensure monotonicity.

FIG. 5 illustrates an example on-device SDR to HDR ITM system 600, in one or more embodiments. In one embodiment, the ITM system 600 is integrated into, or implemented as part of, the electronic device 110 to perform fully automatic on-device SDR to HDR ITM using machine learning. For example, in one embodiment, the one or more applications 170 (FIG. 1) executing/operating on the electronic device 110 include the ITM system 600.

In one embodiment, the ITM system 600 comprises a SDR linearization unit 610 configured to: (1) receive, as input, SDR signals of SDR content 210 with metadata, and (2) convert the SDR signals to linear luminance values. In one embodiment, the linear luminance values comprise, for each SDR image of the SDR content 210, linearized R, G, and B signals corresponding to the SDR image.

In one embodiment, the metadata comprises per frame or scene statistics information for the entire SDR content 210 (e.g., the entire SDR video). For example, in one embodiment, the metadata comprises, for each SDR image of the SDR content 210, a histogram of the SDR image or linear luminance percentiles sampled from a CDF of the SDR image based on pre-defined sampling percentage values (i.e., pre-defined percentages for sampling purposes). The metadata represents heuristic features extracted from the SDR content 210.

In one embodiment, the ITM system 600 comprises a SDR metadata parser unit 620 configured to: (1) receive, as input, SDR signals of SDR content 210 with metadata, and (2) parse, from the SDR signals, the metadata.

In one embodiment, SDR content 210 with metadata is received from a content server 300 on which the SDR content 210 is created and/or the metadata is calculated. For example, an application 330 (FIG. 1) for calculating the metadata (e.g., calculating histogram or linear luminance percentiles) is executing/operating on the content server 300.

In one embodiment, the ITM system 600 comprises a trained machine learning model 630 configured to: (1) receive, as input, metadata corresponding to SDR content 210 (e.g., from the SDR metadata parser unit 620), and (2) generate, based on the corresponding metadata, a set of parameters for a single ITM curve (i.e., the set of parameters characterize the ITM curve). In one embodiment, the corresponding metadata comprises, for each SDR image of the SDR content 210, linear luminance percentiles Lᵢ of the SDR image. In one embodiment, the ITM curve is an n-th order polynomial curve, and the n-th order polynomial curve is one of a Bernstein polynomial curve or a Bézier curve. For example, in one embodiment, the set of parameters comprises n coefficients for a flexible n-th order Bernstein polynomial curve for use in converting the SDR content 210 to HDR content for presentation on the display device 60.

In one embodiment, the machine learning model 630 is further configured to generate, based on the set of parameters, an ITM lookup table (LUT) to facilitate pixel wise ITM. For example, in one embodiment, the ITM LUT comprises SDR-HDR pixel pairs, wherein each SDR-HDR pixel pair includes: (1) a luminance value of a SDR pixel in the SDR content 210, and (2) a luminance value of a predicted HDR pixel in the converted HDR content.

In one embodiment, the machine learning model 630 is trained offline. For example, in one embodiment, a machine learning model 570 (FIG. 3) is trained via a machine learning model training system (e.g., the training system 500 in FIG. 3) deployed on an off-device processing server 340, and the resulting trained machine learning model 570 is deployed on-device (i.e., loaded onto or downloaded to the electronic device 110) as the machine learning model 630.

In one embodiment, no hardware resources of the electronic device 110/display device 60 are required to execute/run the machine learning model 630. For example, in one embodiment, the machine learning model 630 executes/runs utilizing one or more software resources of the electronic device 110/display device 60 instead, such as, but not limited to, a DSP or a CPU. In one embodiment, the ITM LUT is maintained in RAM of the electronic device 110/display device 60.

In one embodiment, the ITM system 600 comprises an ITM curve application unit 640 configured to: (1) receive, as input, either an ITM LUT or a set of parameters for a single ITM curve (e.g., from the machine learning model 630), (2) receive, as input, linear luminance values (e.g., linearized R, G, and B signals) that SDR signals of SDR content 210 are converted to (e.g., from the SDR linearization unit 610), (3) generate, based on the set of parameters, the single ITM curve, and (4) convert the SDR content 210 to HDR content by applying the single ITM curve to the linear luminance values, resulting in luminance signals of the converted HDR content. The luminance signals are provided to the display device 60 for presentation of the converted HDR content on the display device 60.

For each SDR image of the SDR content 210, the converted HDR content comprises predicted HDR pixels corresponding to the SDR image (i.e., HDR pixels that SDR pixels of the SDR image are converted to), and the luminance signals comprise normalized linear luminance values of the predicted HDR pixels.

In one embodiment, the set of parameters received by the ITM curve application unit 640 comprises n pᵢ coefficients for an n-th order Bernstein polynomial curve, and the ITM curve application unit 640 calculates the normalized linear luminance values of predicted HDR pixels using the n pᵢ coefficients in accordance with equation (10) provided below:

$$\tilde{y} = {Σ}_{i = 1}^{n} {p}_{i} ( \begin{matrix}n \\ i\end{matrix} ) {x ( 1 - x )}^{n - i} , \qquad ( 10 )$$

wherein x is a normalized linear luminance value of a SDR pixel, \tilde{y} is a normalized linear luminance value of a predicted HDR pixel, x∈[0, 1], and \tilde{y}∈[0, 1].

In one embodiment, the normalized linear luminance values comprise linearized R, G, and B signals calculated in accordance equations (11)-(13) provided below:

$${R}_{H D R} = {R}_{S D R} * ( \frac{\tilde{y}}{x} ) , \qquad ( 11 )$$

$${G}_{H D R} = {G}_{S D R} * ( \frac{\tilde{y}}{x} ) , and \qquad ( 12 )$$

$${B}_{H D R} = {B}_{S D R} * ( \frac{\tilde{y}}{x} ) , \qquad ( 13 )$$

wherein R_{HDR} is a linearized R signal of the converted HDR content, R_{SDR} is a linearized R signal of the SDR content 210, G_{HDR} is a linearized G signal of the converted HDR content, G_{SDR} is a linearized G signal of the SDR content 210, B_{HDR} is a linearized B signal of the converted HDR content, B_{SDR} is a linearized B signal of the SDR content 210, x is a normalized linear luminance value of a SDR pixel in the SDR content 210, and \tilde{y} is a normalized linear luminance value of a predicted HDR pixel in the converted HDR content.

In one embodiment, the SDR linearization unit 610 and/or the ITM curve application unit 640 executes/operates utilizing one or more hardware resources of the electronic device 110/display device 60 such as, but not limited to, a SoC, an application-specific integrated circuit (ASIC), or a hardware processor.

In one embodiment, metadata corresponding to SDR content 210 is calculated off-device (e.g., on the content server 300), and the SDR content 210 is converted to HDR content on-device (i.e., via the ITM system 600), as shown in FIG. 5.

FIG. 6 illustrates another example on-device SDR to HDR ITM system 700, in one or more embodiments. In one embodiment, the ITM system 700 is integrated into, or implemented as part of, the electronic device 110 to perform fully automatic on-device SDR to HDR ITM using machine learning. For example, in one embodiment, the one or more applications 170 (FIG. 1) executing/operating on the electronic device 110 include the ITM system 700.

In one embodiment, the ITM system 700 comprises a SDR linearization unit 710 configured to: (1) receive, as input, SDR signals of SDR content 220 without any pre-existing metadata, and (2) convert the SDR signals to linear luminance values. In one embodiment, the linear luminance values comprise, for each SDR image of the SDR content 220, linearized R, G, and B signals corresponding to the SDR image.

Unlike FIG. 5 where metadata received by the ITM system 600 is calculated off-device, the ITM system 700 is capable of receiving SDR content 220 without any pre-existing metadata, and calculating metadata corresponding to the SDR content 220 on-device (i.e., on the electronic device 110). In one embodiment, the corresponding metadata comprises, for each SDR image of the SDR content 220, a histogram of the SDR image or linear luminance percentiles sampled from a CDF of the SDR image based on pre-defined sampling percentage values (i.e., pre-defined percentages for sampling purposes). The corresponding metadata represents heuristic features extracted from the SDR content 220.

In one embodiment, metadata corresponding to SDR content 220 may be calculated by one or more components of the ITM system 700 such as, but not limited to, the SDR linearization unit 710 and/or a percentile calculation unit 720.

For example, in one embodiment, for each SDR image of SDR content 220, the SDR linearization unit 710 is configured to: (1) calculate a corresponding maxRGB image by applying a max(R,G,B) function to a RGB image of the SDR image, and (2) calculate a corresponding histogram. For each SDR image of SDR content 220, the percentile calculation unit 720 is configured to: (1) receive, as input, a corresponding histogram, (2) calculate, based on the corresponding histogram, a corresponding CDF, and (3) sample linear luminance percentiles Lᵢ from the corresponding CDF based on pre-defined sampling percentage values.

In one embodiment, the SDR linearization unit 710 calculates maxRGB images and histograms utilizing one or more hardware resources of the electronic device 110/display device 60 such as, but not limited to, a SoC, an ASIC, or a hardware processor. In one embodiment, histograms calculated by the SDR linearization unit 710 are maintained in random-access memory (RAM) of the electronic device 110/display device 60. In one embodiment, the percentile calculation unit 720 calculates linear luminance percentiles utilizing one or more software resources of the electronic device 110/display device 60 such as, but not limited to, a DSP or a CPU.

In one embodiment, the ITM system 700 comprises a trained machine learning model 730 configured to: (1) receive, as input, metadata corresponding to SDR content 220 (e.g., from the percentile calculation unit 720), and (2) generate, based on the corresponding metadata, a set of parameters for a single ITM curve (i.e., the set of parameters characterize the ITM curve). In one embodiment, the corresponding metadata comprises, for each SDR image of the SDR content 220, linear luminance percentiles Lᵢ of the SDR image. In one embodiment, the ITM curve is an n-th order polynomial curve, and the n-th order polynomial curve is one of a Bernstein polynomial curve or a Bézier curve. For example, in one embodiment, the set of parameters comprises n coefficients for a flexible n-th order Bernstein polynomial curve for use in converting the SDR content 220 to HDR content for presentation on the display device 60.

In one embodiment, the machine learning model 730 is further configured to generate, based on the set of parameters, an ITM LUT to facilitate pixel wise ITM. For example, in one embodiment, the ITM LUT comprises SDR-HDR pixel pairs, wherein each SDR-HDR pixel pair includes: (1) a luminance value of a SDR pixel in the SDR content 220, and (2) a luminance value of a predicted HDR pixel in the converted HDR content.

In one embodiment, the machine learning model 730 is trained offline. For example, in one embodiment, a machine learning model 570 (FIG. 3) is trained via a machine learning model training system (e.g., the training system 500 in FIG. 3) deployed on an off-device processing server 340, and the resulting trained machine learning model 570 is deployed on-device (i.e., loaded onto or downloaded to the electronic device 110) as the machine learning model 730.

In one embodiment, no hardware resources of the electronic device 110/display device 60 are required to execute/run the machine learning model 730. For example, in one embodiment, the machine learning model 730 executes/runs utilizing one or more software resources of the electronic device 110/display device 60 instead, such as a DSP or a CPU. In one embodiment, the ITM LUT is maintained in RAM of the electronic device 110/display device 60.

In one embodiment, the ITM system 700 comprises an ITM curve application unit 740 configured to: (1) receive, as input, either an ITM LUT or a set of parameters for a single ITM curve (e.g., from the machine learning model 730), (2) receive, as input, linear luminance values (e.g., linearized R, G, and B signals) that SDR signals of SDR content 220 are converted to (e.g., from the SDR linearization unit 710), (3) generate, based on the inputs, the single ITM curve, and (4) convert the SDR content 220 to HDR content by applying the single ITM curve to the linear luminance values, resulting in luminance signals of the converted HDR content. The luminance signals are provided to the display device 60 for presentation of the converted HDR content on the display device 60.

For each SDR image of the SDR content 220, the converted HDR content comprises predicted HDR pixels corresponding to the SDR image (i.e., HDR pixels that SDR pixels of the SDR image are converted to), and the luminance signals comprise normalized linear luminance values of the predicted HDR pixels.

In one embodiment, the set of parameters received by the ITM curve application unit 740 comprises n pᵢ coefficients for an n-th order Bernstein polynomial curve, and the ITM curve application unit 740 calculates the normalized linear luminance values of predicted HDR pixels using the n pᵢ coefficients in accordance with equation (10) provided above.

In one embodiment, the normalized linear luminance values comprise linearized R, G, and B signals calculated in accordance equations (11)-(13) provided above.

In one embodiment, the SDR linearization unit 710 and/or the ITM curve application unit 740 executes/operates utilizing one or more hardware resources of the electronic device 110/display device 60 such as, but not limited to, a SoC, an ASIC, or a hardware processor.

In one embodiment, metadata corresponding to SDR content 220 is calculated on-device (i.e., via the ITM system 700), and the SDR content 220 is converted to HDR content on-device (i.e., via the ITM system 700), as shown in FIG. 6.

Alternatively, in another embodiment, fully automatic SDR to HDR ITM using machine learning is performed off-device (i.e., not on the electronic device 110). FIG. 7 illustrates an example off-device SDR to HDR ITM system 800, in one or more embodiments. In one embodiment, the ITM system 800 is integrated into, or implemented as part of, the content server 300 to perform fully automatic off-device SDR to HDR ITM using machine learning. For example, in one embodiment, the one or more applications 330 (FIG. 1) executing/operating on the content server 300 include the ITM system 800.

In one embodiment, the ITM system 800 comprises a SDR linearization unit 810 configured to: (1) obtain, as input, SDR signals of SDR content 230 without any pre-existing metadata, and (2) convert the SDR signals to linear luminance values. In one embodiment, the linear luminance values comprise, for each SDR image of the SDR content 230, linearized R, G, and B signals corresponding to the SDR image.

The ITM system 800 is capable of obtaining SDR content 230 without any pre-existing metadata, and calculating metadata corresponding to the SDR content 230. In one embodiment, the corresponding metadata can be calculated on the content server 300 when the SDR content 230 is created. In one embodiment, the corresponding metadata comprises, for each SDR image of the SDR content 230, a histogram of the SDR image or linear luminance percentiles sampled from a CDF of the SDR image based on pre-defined sampling percentage values (i.e., pre-defined percentages for sampling purposes). The corresponding metadata represents heuristic features extracted from the SDR content 230.

In one embodiment, metadata corresponding to SDR content 230 may be calculated by one or more components of the ITM system 800 such as, but not limited to, the SDR linearization unit 810 and/or a percentile calculation unit 820.

For example, in one embodiment, for each SDR image of SDR content 230, the SDR linearization unit 810 is configured to: (1) calculate a corresponding maxRGB image by applying a max(R,G,B) function to a RGB image of the SDR image, and (2) calculate a corresponding histogram. For each SDR image of SDR content 230, the percentile calculation unit 820 is configured to: (1) receive, as input, a corresponding histogram, (2) calculate, based on the corresponding histogram, a corresponding CDF, and (3) sample linear luminance percentiles Lᵢ from the corresponding CDF based on pre-defined sampling percentage values.

In one embodiment, the SDR linearization unit 810 calculates maxRGB images and histograms utilizing one or more hardware resources of the content server 300 such as, but not limited to, a SoC, an ASIC, or a hardware processor. In one embodiment, histograms calculated by the SDR linearization unit 810 are maintained in random-access memory (RAM) of the content server 300. In one embodiment, the percentile calculation unit 820 calculates linear luminance percentiles utilizing one or more software resources of the content server 300 such as, but not limited to, a DSP or a CPU.

In one embodiment, the ITM system 800 comprises a trained machine learning model 830 configured to: (1) receive, as input, metadata corresponding to SDR content 230 (e.g., from the percentile calculation unit 820), and (2) generate, based on the corresponding metadata, a set of parameters for a single ITM curve (i.e., the set of parameters characterize the ITM curve). In one embodiment, the corresponding metadata comprises, for each SDR image of the SDR content 230, linear luminance percentiles Lᵢ of the SDR image. In one embodiment, the ITM curve is an n-th order polynomial curve, and the n-th order polynomial curve is one of a Bernstein polynomial curve or a Bézier curve. For example, in one embodiment, the set of parameters comprises n coefficients for a flexible n-th order Bernstein polynomial curve for use in converting the SDR content 230 to HDR content.

In one embodiment, the machine learning model 830 is further configured to generate, based on the set of parameters, an ITM LUT to facilitate pixel wise ITM. For example, in one embodiment, the ITM LUT comprises SDR-HDR pixel pairs, wherein each SDR-HDR pixel pair includes: (1) a luminance value of a SDR pixel in the SDR content 230, and (2) a luminance value of a predicted HDR pixel in the converted HDR content.

In one embodiment, the machine learning model 830 is trained on an off-device processing server 340. For example, in one embodiment, a machine learning model 570 (FIG. 3) is trained via a machine learning model training system (e.g., the training system 500 in FIG. 3) deployed on an off-device processing server 340, and the resulting trained machine learning model 570 is deployed on the content server 300 (i.e., loaded onto or downloaded to the content server 300) as the machine learning model 830.

In one embodiment, no hardware resources of the content server 300 are required to execute/run the machine learning model 830. For example, in one embodiment, the machine learning model 830 executes/runs utilizing one or more software resources of the content server 300 instead, such as a DSP or a CPU. In one embodiment, the ITM LUT is maintained in RAM of the content server 300.

In one embodiment, the ITM system 800 comprises an ITM curve application unit 840 configured to: (1) receive, as input, either an ITM LUT or a set of parameters for a single ITM curve (e.g., from the machine learning model 830), (2) receive, as input, linear luminance values (e.g., linearized R, G, and B signals) that SDR signals of SDR content 230 are converted to (e.g., from the SDR linearization unit 810), (3) generate, based on the inputs, the single ITM curve, and (4) convert the SDR content 230 to HDR content by applying the single ITM curve to the linear luminance values, resulting in luminance signals of the converted HDR content.

For each SDR image of the SDR content 230, the converted HDR content comprises predicted HDR pixels corresponding to the SDR image (i.e., HDR pixels that SDR pixels of the SDR image are converted to), and the luminance signals comprise normalized linear luminance values of the predicted HDR pixels.

In one embodiment, the set of parameters received by the ITM curve application unit 840 comprises n pᵢ coefficients for an n-th order Bernstein polynomial curve, and the ITM curve application unit 840 calculates the normalized linear luminance values of predicted HDR pixels using the n pᵢ coefficients in accordance with equation (10) provided above.

In one embodiment, the normalized linear luminance values comprise linearized R, G, and B signals calculated in accordance equations (11)-(13) provided above.

In one embodiment, the SDR linearization unit 810 and/or the ITM curve application unit 840 executes/operates utilizing one or more hardware resources of the content server 300 such as, but not limited to, a SoC, an ASIC, or a hardware processor.

In one embodiment, the ITM system 800 comprises a Perceptual Quantization (PQ) or Hybrid Log Gamma (HLG) Opto-electronic Transfer Function (OETF) unit 850 configured to: (1) receive, as input, luminance signals of converted HDR content (e.g., from the ITM curve application unit 840), and (2) apply a HDR OETF function to the luminance signals, resulting in an OETF video signal of converted HDR content. In one embodiment, the OETF video signal comprises PQ or HLG code values.

In one embodiment, the ITM system 800 comprises a video encoding unit 860 configured to: (1) receive, as input, an OETF video signal of converted HDR content (e.g., from the OETF unit 850), (2) perform encoding on the OETF video signal using one or more codecs, resulting in encoded HDR content, and (3) provide the encoded HDR content for transmission via the communications network 50. The encoded HDR content is provided to the electronic device 110 for presentation on the display device 60.

In one embodiment, metadata corresponding to SDR content 230 is calculated off-device (i.e., via the ITM system 800), and the SDR content 230 is converted to HDR content 240 off-device (i.e., via the ITM system 800), as shown in FIG. 7.

One or more embodiments may be implemented in a TV (or other electronic device 110) to display SDR content with improved picture quality (i.e., converted to HDR content). In one embodiment, different picture modes are available on the TV for user selection, such that SDR content (received as input) may be converted to HDR content (provided as output) with different color gradings. Specifically, each picture mode represents a particular creative intent (e.g., creative intent of a particular color grading expert), and the picture mode performs SDR to HDR ITM utilizing a unique machine learning model trained based on a ground truth HDR dataset representing the creative intent (e.g., generated by the color grading expert via the ground truth HDR mastering system 400 in FIG. 2). In one embodiment, the TV self-learns user preferences in relation to displaying HDR content (e.g., which picture mode is user preferred).

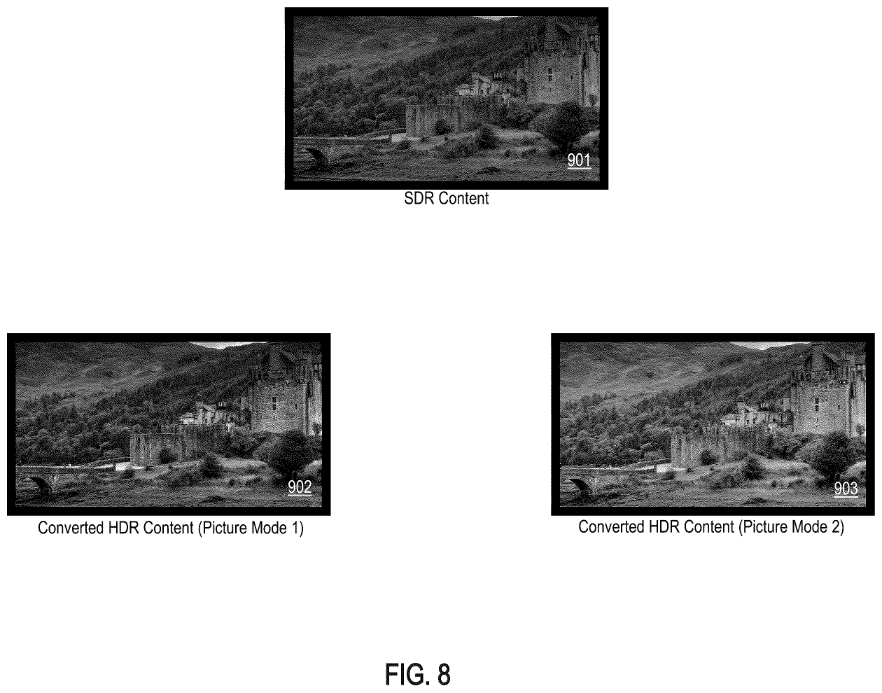

FIG. 8 illustrates an example of visual differences between SDR content and converted HDR content, in one or more embodiments. As shown in FIG. 8, SDR content 901 appears darker and/or has a lower degree of color clarity and contrast when presented without ITM on a consumer display (e.g., a display device 60) with HDR rendering capabilities. By comparison, when the SDR content 901 is converted to HDR content using a single ITM curve generated by machine learning, the resulting converted HDR content—such as converted HDR content 902 if a first picture mode (Picture Mode 1) is user selected, or converted HDR content 903 if a second picture mode (Picture Mode 2) is user selected—appears brighter and/or has a higher degree of color clarity and contrast, thereby improving picture quality.

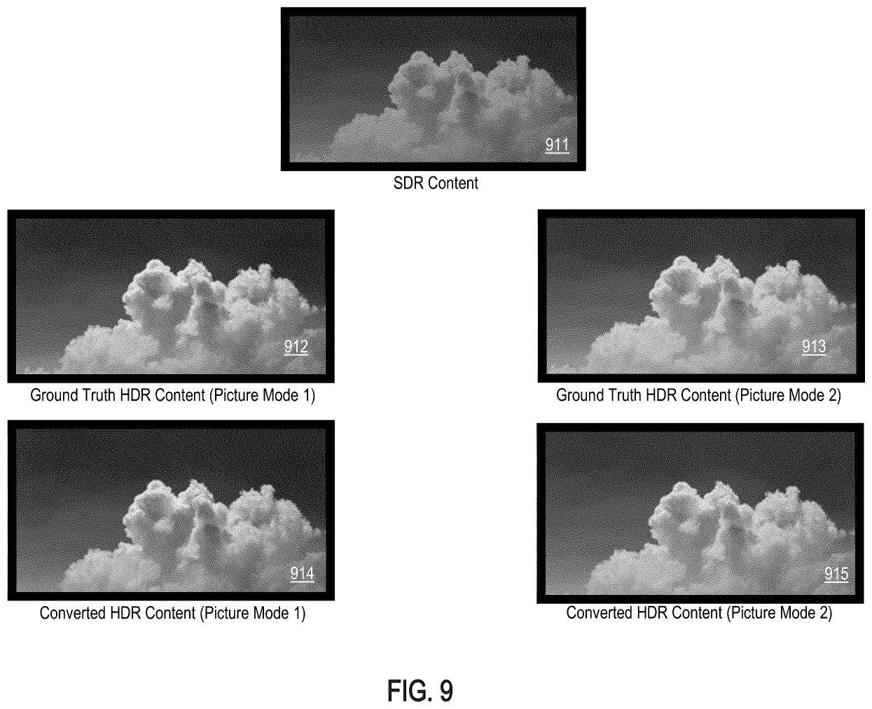

FIG. 9 illustrates an example of visual differences between SDR content, ground truth HDR content, and converted HDR content, in one or more embodiments. As shown in FIG. 9, SDR content 911 appears darker and/or has a lower degree of color clarity and contrast when presented without ITM on a consumer display (e.g., a display device 60) with HDR rendering capabilities. By comparison, when the SDR content 911 is color graded by a color grading expert at a studio, the resulting ground truth HDR content—such as ground truth HDR content 912 color graded by a first color grading expert representing a first picture mode (Picture Mode 1), or ground truth HDR content 913 color graded by a second color grading expert representing a second picture mode (Picture Mode 2)—appears brighter and/or has a higher degree of color clarity and contrast, thereby improving picture quality.

Further, when the SDR content 911 is converted to HDR content using a machine learning model trained based on the ground truth HDR content, the resulting converted HDR content—such as converted HDR content 914 if the first picture mode (Picture Mode 1) is user selected, or converted HDR content 915 if the second picture mode (Picture Mode 2) is user selected—appears brighter and/or has a higher degree of color clarity and contrast, thereby improving picture quality.

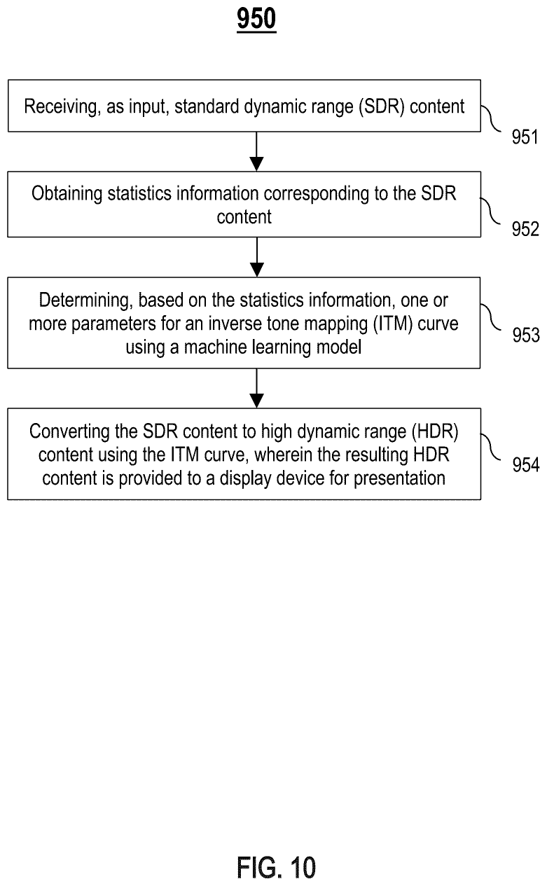

FIG. 10 is a flowchart of an example process 950 for fully automatic SDR to HDR ITM using machine learning, in one or more embodiments. Process block 951 includes receiving, as input, SDR content (e.g., SDR content 210 in FIG. 5, SDR content 220 in FIG. 6, or SDR content 230 in FIG. 7). Process block 952 includes obtaining statistics information corresponding to the SDR content (e.g., parsing metadata including linear luminance percentiles via SDR metadata parser unit 620 in FIG. 5, calculating linear luminance percentiles via percentile calculation unit 720 in FIG. 6, or calculating linear luminance percentiles via percentile calculation unit 820 in FIG. 7). Process block 953 includes determining, based on the statistics information, one or more parameters for an ITM curve using a machine learning model (e.g., MLM 570 in FIG. 3, MLM 630 in FIG. 5, MLM 730 in FIG. 6, or MLM 830 in FIG. 7). Process block 954 includes converting the SDR content to HDR content using the ITM curve (e.g., via ITM curve application unit 640 in FIG. 5, ITM curve application unit 740 in FIG. 6, ITM curve application unit 840 in FIG. 7), wherein the resulting HDR content is provided to a display device (e.g., display device 60 in FIG. 1) for presentation.

In one embodiment, process blocks 951-954 may be performed by one or more components of the SDR to HDR ITM system 600, the SDR to HDR ITM system 700, and/or the SDR to HDR ITM system 800.

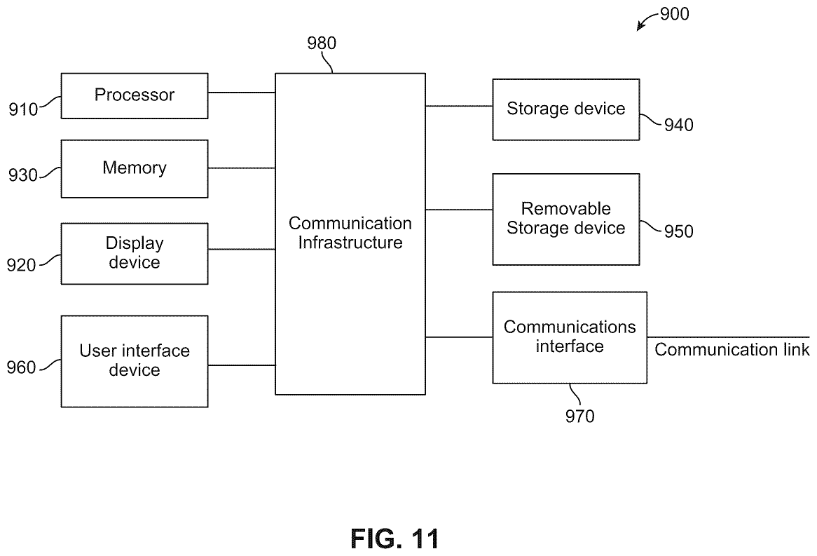

FIG. 11 is a high-level block diagram showing an information processing system comprising a computer system 900 useful for implementing the disclosed embodiments. The systems 400, 500, 600, 700, and/or 800 may be incorporated in the computer system 900. The computer system 900 includes one or more processors 910, and can further include an electronic display device 920 (for displaying video, graphics, text, and other data), a main memory 930 (e.g., random access memory (RAM)), storage device 940 (e.g., hard disk drive), removable storage device 950 (e.g., removable storage drive, removable memory module, a magnetic tape drive, optical disk drive, computer readable medium having stored therein computer software and/or data), viewer interface device 960 (e.g., keyboard, touch screen, keypad, pointing device), and a communication interface 970 (e.g., modem, a network interface (such as an Ethernet card), a communications port, or a PCMCIA slot and card). The communication interface 970 allows software and data to be transferred between the computer system and external devices. The system 900 further includes a communications infrastructure 980 (e.g., a communications bus, cross-over bar, or network) to which the aforementioned devices/modules 910 through 970 are connected.

Information transferred via communications interface 970 may be in the form of signals such as electronic, electromagnetic, optical, or other signals capable of being received by communications interface 970, via a communication link that carries signals and may be implemented using wire or cable, fiber optics, a phone line, a cellular phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to generate a computer implemented process. In one embodiment, processing instructions for process 950 (FIG. 10) may be stored as program instructions on the memory 930, storage device 940, and/or the removable storage device 950 for execution by the processor 910.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A method comprising:
receiving, as input, standard dynamic range (SDR) content;
obtaining statistics information corresponding to the SDR content;
determining, based on the statistics information, one or more parameters for an inverse tone mapping (ITM) curve using a machine learning model; and
converting the SDR content to high dynamic range (HDR) content using the ITM curve, wherein the resulting HDR content is provided to a display device for presentation.

2. The method of claim 1, wherein the display device has HDR rendering capabilities.

3. The method of claim 1, wherein the statistics information comprises, for each SDR image of the SDR content, at least one of a histogram of the SDR image or linear luminance percentiles sampled from a cumulated distribution function (CDF) of the SDR image based on pre-defined sampling percentage values.

4. The method of claim 1, wherein obtaining statistics information corresponding to the SDR content comprises:
parsing metadata corresponding to the SDR content from SDR signals of the SDR content, wherein the metadata comprises the statistics information.

5. The method of claim 1, wherein obtaining statistics information corresponding to the SDR content comprises:
for each SDR image of the SDR content:
calculating a histogram of the SDR image;
calculating a cumulated distribution function (CDF) of the SDR image based on the histogram of the SDR image; and
sampling linear luminance percentiles from the CDF of the SDR image based on pre-defined sampling percentage values.

6. The method of claim 1, wherein the ITM curve is an n-th order polynomial curve.

7. The method of claim 6, wherein the n-th order polynomial curve is one of a Bernstein polynomial curve or a Bézier curve.

8. The method of claim 1, wherein the machine learning model is trained offline.

9. The method of claim 8, further comprising:
obtaining one or more SDR training samples;
obtaining one or more HDR training samples resulting from color grading of the one or more SDR training samples;
converting the one or more SDR training samples to linear luminance values;
calculating linear luminance percentiles of the one or more SDR training samples based on the linear luminance values;
determining one or more constrained least square parameters for a ground truth ITM curve based on the linear luminance values and the one or more HDR training samples; and
training the machine learning model based on the linear luminance percentiles and the one or more constrained least square parameters.

10. The method of claim 1, wherein the machine learning model is implemented in a Digital Signal Processor (DSP) or a central processing unit (CPU) of the display device.

11. A system comprising:
at least one processor; and
a non-transitory processor-readable memory device storing instructions that when executed by the at least one processor causes the at least one processor to perform operations including:
receiving, as input, standard dynamic range (SDR) content;
obtaining statistics information corresponding to the SDR content;
determining, based on the statistics information, one or more parameters for an inverse tone mapping (ITM) curve using a machine learning model; and
converting the SDR content to high dynamic range (HDR) content using the ITM curve, wherein the resulting HDR content is provided to a display device for presentation.

12. The system of claim 11, wherein the statistics information comprises, for each SDR image of the SDR content, at least one of a histogram of the SDR image or linear luminance percentiles sampled from a cumulated distribution function (CDF) of the SDR image based on pre-defined sampling percentage values.

13. The system of claim 11, wherein the ITM curve is an n-th order polynomial curve, and the n-th order polynomial curve is one of a Bernstein polynomial curve or a Bézier curve.

14. The system of claim 11, wherein the machine learning model is trained offline.

15. The system of claim 14, wherein the operations further include:
obtaining one or more SDR training samples;
obtaining one or more HDR training samples resulting from color grading of the one or more SDR training samples;
converting the one or more SDR training samples to linear luminance values;
calculating linear luminance percentiles of the one or more SDR training samples based on the linear luminance values;
determining one or more constrained least square parameters for a ground truth ITM curve based on the linear luminance values and the one or more HDR training samples; and
training the machine learning model based on the linear luminance percentiles and the one or more constrained least square parameters.

16. The system of claim 11, wherein the machine learning model is implemented in a Digital Signal Processor (DSP) or a central processing unit (CPU) of the display device.

17. A non-transitory processor-readable medium that includes a program that when executed by a processor performs a method comprising:
receiving, as input, standard dynamic range (SDR) content;
obtaining statistics information corresponding to the SDR content;
determining, based on the statistics information, one or more parameters for an inverse tone mapping (ITM) curve using a machine learning model; and
converting the SDR content to high dynamic range (HDR) content using the ITM curve, wherein the resulting HDR content is provided to a display device for presentation.

18. The non-transitory processor-readable medium of claim 17, wherein the statistics information comprises, for each SDR image of the SDR content, at least one of a histogram of the SDR image or linear luminance percentiles sampled from a cumulated distribution function (CDF) of the SDR image based on pre-defined sampling percentage values.

19. The non-transitory processor-readable medium of claim 17, wherein the ITM curve is an n-th order polynomial curve, and the n-th order polynomial curve is one of a Bernstein polynomial curve or a Bézier curve.

20. The non-transitory processor-readable medium of claim 17, wherein the machine learning model is implemented in a Digital Signal Processor (DSP) or a central processing unit (CPU) of the display device.
